(19) United States
(12) Patent Application Publication
(10) Pub. No.: US 2008/0179870 A1
(43) Pub. Date: Jul. 31, 2008

(54) UNIVERSAL CHASSIS

(75) Inventor: Chris P. Theodore, Birmingham, MI (US)

Correspondence Address: HARNESS, DICKEY & PIERCE, P.L.C., P.O. BOX 828, BLOOMFIELD HILLS, MI, 48303, US

(73) Assignee: Theodore & Associates LLC, Birmingham, MI (US)

(21) Appl. No.: 12/019,490

(22) Filed: Jan. 24, 2008

Related U.S. Application Data
(60) Provisional application No. 60/897,771, filed on Jan. 26, 2007.

(51) Int. Cl. B62D 21/04; B21D 53/88

(52) U.S. Cl. 280/786; 280/798; 29/897.2

(57) ABSTRACT

A vehicle chassis that incorporates the engine structure, transaxle structure and a backbone structure provided as a unitary structure onto which other components of a vehicle, such as suspension, steering, body and crash absorbers may be attached. The backbone structure is a closed tubular structure in which a relatively rigid drive shaft can be supported for rotational power delivery between the engine and the transaxle. Several variations of the basic chassis embodiment are disclosed to accommodate rear wheel drive, front wheel drive, four wheel drive, as well as internal combustion, electrical and hybrid powered vehicles.

### CROSS-REFERENCE TO RELATED APPLICATIONS

This application claims the benefit of U.S. Provisional Application No. 60/897,771, filed on Jan. 26, 2007. The disclosure of the above application is incorporated herein by reference.

### FIELD

This invention is related to the field of automotive chassis design and more specifically to the area of interchangeable chassis for use with many models of vehicles.

### BACKGROUND

The statements in this section merely provide background information related to the present disclosure and may not constitute prior art.

Traditionally, vehicles are made up on framed chassis or on a rigid uni-body chassis. These two types of chassis have both advantages and disadvantages when compared to each other and are well known in the automotive industry. A main deficiency attributed to each of the traditional chassis types is that they are not readily adaptable to a wide variety of vehicles without forcing major and expensive redesign work for each vehicle. As a result, almost every vehicle model of vehicle has a unique chassis that is unusable for other vehicle designs. The present invention is based on an attempt to address the disadvantages known in the two commonly used chassis types and also to provide a simple chassis that can be used in a wide variety of vehicle designs.

### SUMMARY

The unique features of this invention include the combination of a rigid backbone structure connecting front and rear structures (in the preferred embodiment, the front engine and rear transaxle), in combination with the front and rear suspensions affixed to the front and rear structures (or backbone mounting surfaces), to create a complete, self-supporting chassis without the need for a separate frame, or the need to attach the front and rear subassemblies to a rigid uni-body.

The problems solved by the present invention include an ability to attach different bodies, or body styles to the same uni-chassis; an ability to scale the uni-chassis to different size vehicles (e.g., wheelbase) by increasing or decreasing the length of the backbone structure. Weight savings are provided by using the backbone to serve the functions of (1) torsion and bending support for the chassis and (2) a torque tube to support drive torque from the engine to transaxle through a quill shaft mounted inside the backbone. Other problems solved by the present invention include an ability to de-couple chassis loads (e.g., ride and handling loads including drive, braking, steering) from body loads and impact (crash) loads; an ability to create a “rolling chassis”, before installation of the body structure; an ability to reduce weight by stressing the normally unstressed engine and transaxle structures with chassis loads; and an ability to optimize total vehicle weight, weight distribution and minimize polar moment of inertia (about the yaw axis) through minimization of weight and location of the major vehicle masses within the wheelbase of the vehicle.

Advantages of the present invention over prior constructions are simplicity (minimizing cost and manufacturing investment), weight reduction, reduction in polar moment of inertia about the yaw axis, and an ability to adapt to different bodies and body styles and create a rolling chassis. Other advantages include elimination of a traditional frame and its associated weight and cost, or the need to transfer suspension loads into a uni-body structure, which also effects weight and cost; and flexibility in creating unique chassis for different engines, transaxles and suspension components while maintaining the same uni-chassis architecture. Thus, a series of modules could be created for front, rear and backbone structures, allowing the creation of many different chassis using the three essential building blocks (front, backbone, and rear structures). Still further advantages are an ability to scale the uni-chassis to different sizes and de-couple chassis loads from body loads.

The sales and market potential of this invention are particularly well suited to specialty vehicles since multiple vehicles can be made off the same uni-chassis. Manufacturing investment is low. The uni-chassis is scaleable to different sizes. The uni-chassis is modular, in that different front, rear and backbone modules can be combined to create different chassis. The uni-chassis can be sold as a complete rolling chassis, or as three independent modules, to the aftermarket, allowing others to create unique vehicles.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic plan view of a universal chassis according to one example of the present teachings and shown on an exemplary vehicle;

FIG. 2 is a detail plan view of the universal chassis of FIG. 1;

FIG. 3 is a perspective view of the universal chassis of FIG. 1 illustrating a backbone structure coupled to a front and rear structure according to one example;

FIG. 4 is a cross-sectional view of the universal chassis taken along line 4-4 of FIG. 3;

FIG. 5 is a front perspective view of a bell housing associated with the universal chassis of FIG. 3;

FIG. 6 is a cross-sectional view of the bell housing taken along line 6-6 at FIG. 5;

FIG. 7 is a side view of the universal chassis shown coupled to the rear structure of FIG. 3;

FIG. 8 is a detail side view of the rear structure of FIG. 7;

FIG. 9 is a partial front view of the front structure of the universal chassis of FIG. 3 and shown with suspension elements represented as being attached to an engine structure.

FIG. 10 is a cross-sectional view of an exemplary universal chassis represented as being associated with a vehicle body;

FIG. 11 is a top view of a universal chassis shown with body mounts according to additional features;

FIG. 12 represents the universal chassis according to the present teachings that accommodates various rear wheel drive configurations;

FIG. 13 represents the universal chassis according to the present teachings that accommodates various front wheel drive configurations;

FIG. 14 represents the universal chassis according to the present teachings that accommodates various four wheel drive configurations;

FIG. 15 represents the universal chassis according to the present teachings that accommodates an electrically powered four wheel drive configuration;

FIG. 16 represents the universal chassis according to the present teachings that accommodates a plug-in series hybrid type powertrain configuration; and

FIG. 17 represents the universal chassis according to the present teachings that accommodates a dual-mode hybrid type configuration.

### DETAILED DESCRIPTION

The following description is merely exemplary in nature and is not intended to limit the present disclosure, application, or uses.

While the present invention is summarized above as being applicable for several types of vehicles, it is exemplified herein as being installed in a conventional front engine vehicle with a rear transaxle.

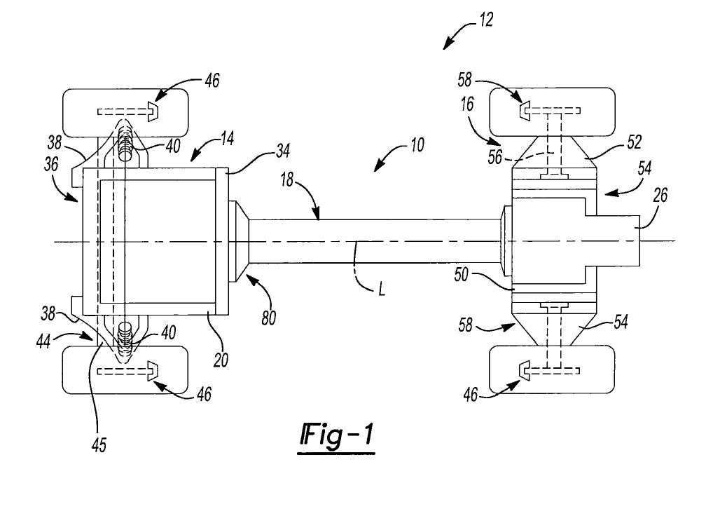

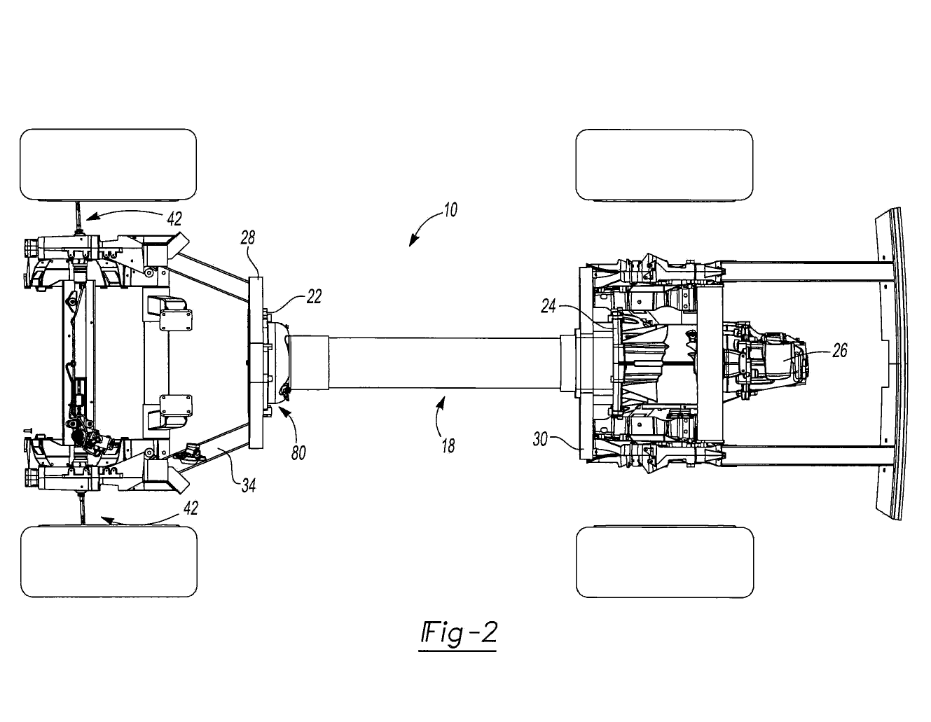

Referring initially to FIGS. 1 and 2, a plan view of a unitary or uni-chassis constructed in accordance to the present teachings is shown and generally identified at reference numeral 10. The uni-chassis 10 is shown associated with an exemplary vehicle 12. The uni-chassis 10 includes three major assemblies: a front structure 14, a rear structure 16 and a backbone structure 18. The front structure 14 can be built up around an engine 20. The backbone structure 18 is rigidly attached to the front structure 14 through a front mounting flange 22 (FIG. 2) and rigidly attached to the rear structure 16 through a rear mounting flange 24 (FIG. 2). The rear structure 16 is built up around a transaxle 26. As shown in FIG. 2, a front and rear mounting plate 28 and 30 may be incorporated to couple the front and rear mounting flanges 22 and 24 to the front and rear structures 14 and 16, respectively.

The front structure 14 includes the engine 20 supported by a cross-member or sub-frame 34. In one example, the front structure 14 can be integrally defined with the front mounting plate 28. Attached to the engine 20 and front sub-frame 34 are all the front chassis systems typically mounted to a chassis, including, but not limited to: a suspension system 36 with control arms 38, springs and dampers 40, knuckle and spindle 42; steering system 44 including rack and pinion 45 and tie rods; tire/wheel/brake assemblies 46 attached to the suspension spindle and knuckle; accessory drives including power steering pump, water pump, alternator, etc. (not specifically shown), attached to the engine 20 and front sub-frame 34. Optionally, a vehicle cooling system and front energy management structure can be incorporated in the front structure 14.

The rear structure 16 of the preferred embodiment, as shown in FIG. 1, consists of the transaxle 26 with a cross-member or rear sub-frame 50 attached to it, and optionally, to the rear mounting flange 24 of the backbone structure 18. Attached to the transaxle 26 and cross member or rear sub-frame 50 are all the rear chassis systems typically mounted to a chassis, including, but not limited to: a rear suspension system 52 including control arms 54, springs and dampers, knuckle and spindle (not specifically shown); drive shafts 56; and tire/wheel/brake assemblies 58 attached to the knuckle. Optionally, the fuel tank and rear energy management structure (not specifically shown) can be attached to the rear structure 16.

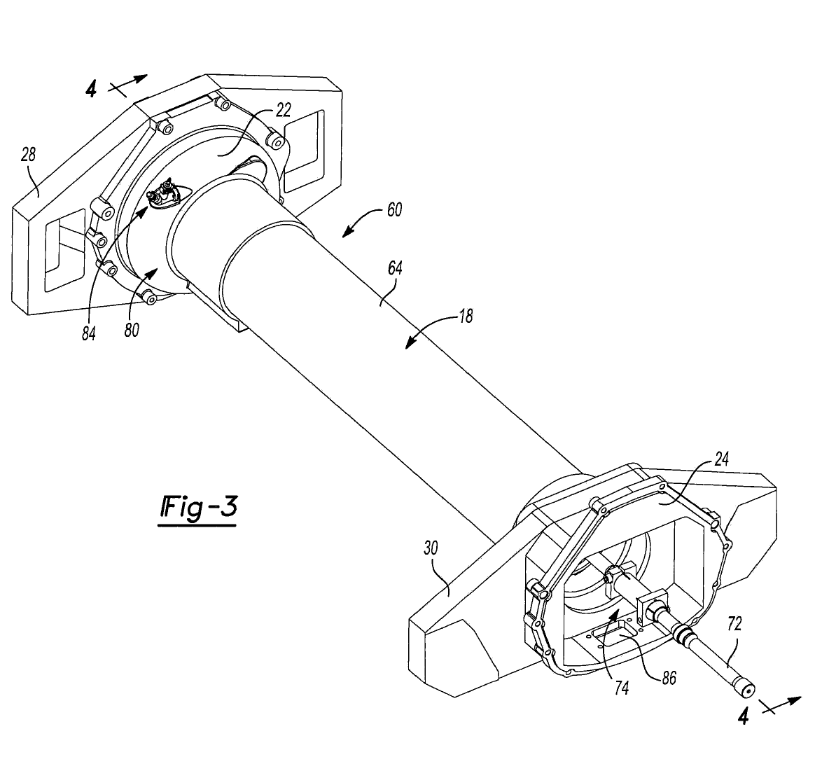

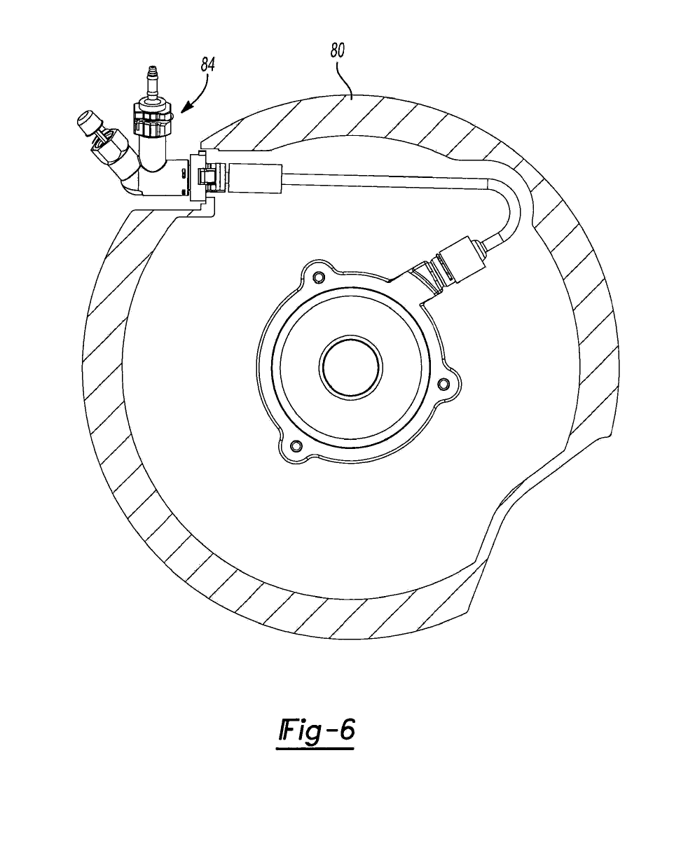

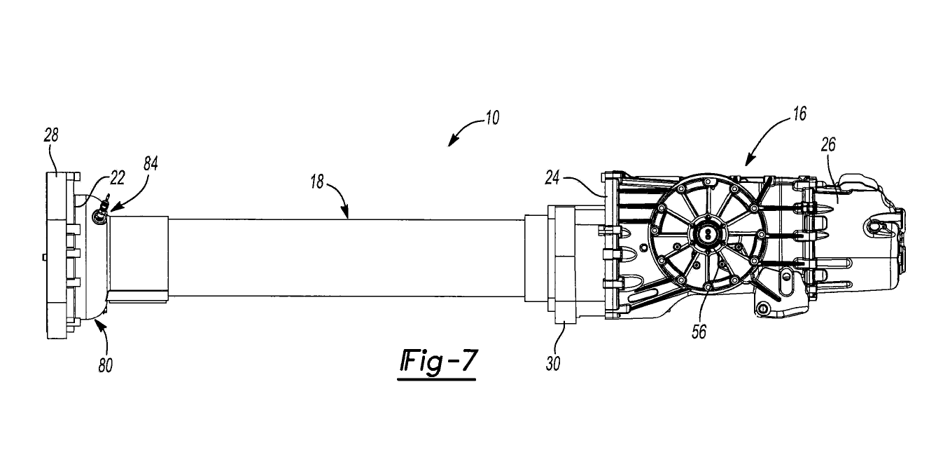

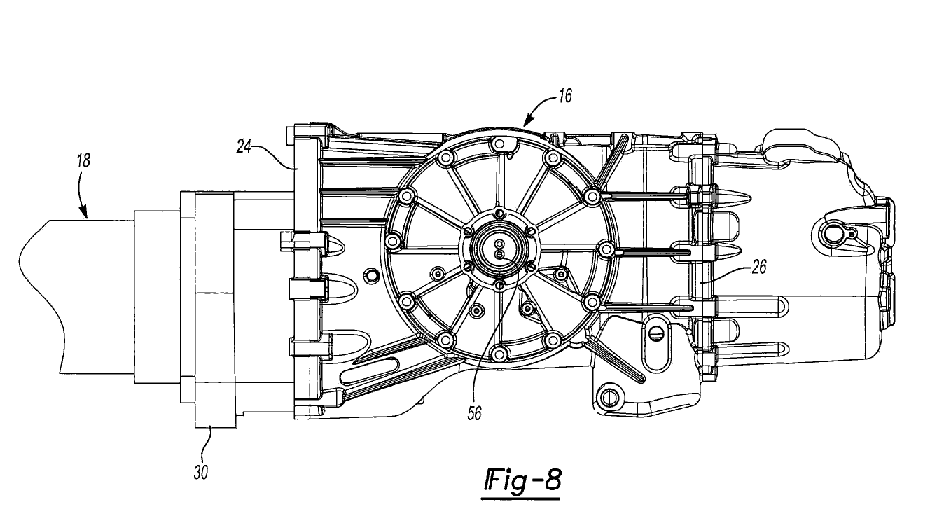

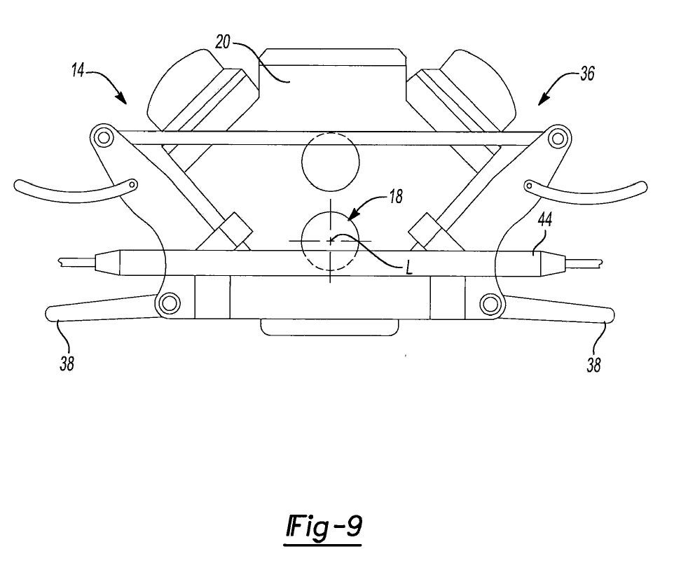

With additional reference now to FIGS. 3-9, the backbone structure 18 includes a main section 60 having the front mounting flange 22 and the rear mounting flange 24. As described, the front and rear mounting flanges 22 and 24 can be coupled to the front structure 14 and rear structure 16, respectively (FIG. 1) by way of conventional fasteners. Alternatively, the backbone structure 18 can be partially or entirely coupled to the front and/or rear structures 14 and 16 by other methods, such as, but not limited to, welding. In addition, the backbone structure 18 can be integrally formed with the front and/or rear structures 14 and 16.

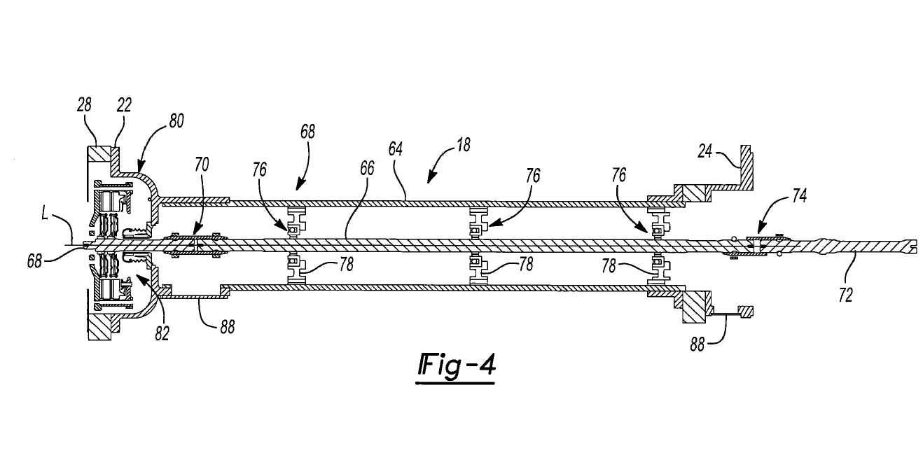

The main section 60 defines a tube 64 having a quill shaft 66 (FIG. 4) rotatably disposed therewithin. The quill shaft 66 can be co-axial to a longitudinal centerline L of the tube 64. The quill shaft 66 is attached at a front end to an engine output shaft 68 through a first coupler 70. The quill shaft 66 is attached at a rear end to a transaxle input shaft 72 through a second coupler 74. The quill shaft 66 is supported by isolated bearings 76 mounted inside and attached to the backbone structure 18, in order to control run-out of the quill shaft 66. The isolated bearings 76 are supported by bearing supports 78. In one example, the front mounting flange 22 may be integrally formed with a bell housing 80. The bell housing 80 can house a flywheel/clutch assembly 82 and also define a bleeder assembly 84.

The primary function of the backbone structure 18 is to rigidly connect the front and rear structures 14 and 16 to form the uni-chassis 10. The backbone 18 is a closed tubular structure, and as shown in the preferred embodiment, has the tube 64 that defines a circular cross-section. The tube 64 may be changed in size and form to optimize backbone properties. The size, shape and material of the backbone structure 18 must be selected so that acting in unison with the front and rear structures 14 and 16, the uni-chassis 10 provides sufficient torsional and bending rigidity and strength. Because the uni-chassis 10 does not incorporate a conventional frame, the backbone structure 18 forms the connection between the front and rear structures 14 and 16. The chassis loads are therefore transmitted solely by the backbone structure 18 between the first and second structures 14 and 16.

In a typical automotive application, the backbone structure 18 should provide approximately 10,000 ft-lb/deg. (minimally 4000) torsional stiffness and 25,000 lb/in (minimally 10,000) bending stiffness; and must have sufficient strength, such that it can withstand at least 2 g vehicle loads in bending and torsion (transmitted through the suspensions 38 and 52 of the front and rear structures 14 and 16, respectively), without permanent yield. In one example, the tube 64 can define an outer diameter of between 6 and 10 inches, and preferably 8 inches. The tube 64 can be formed of a rigid lightweight material such as, but not limited to, aluminum. The tube 64 can have a wall thickness of substantially about 0.5 inch.

The secondary function of the backbone structure 18 as shown in the preferred embodiment is to act as a torque tube to provide support for the transfer of torque from the engine 20 in the front structure 14 to the transaxle 26 in rear structure 16 through the quill shaft 66.

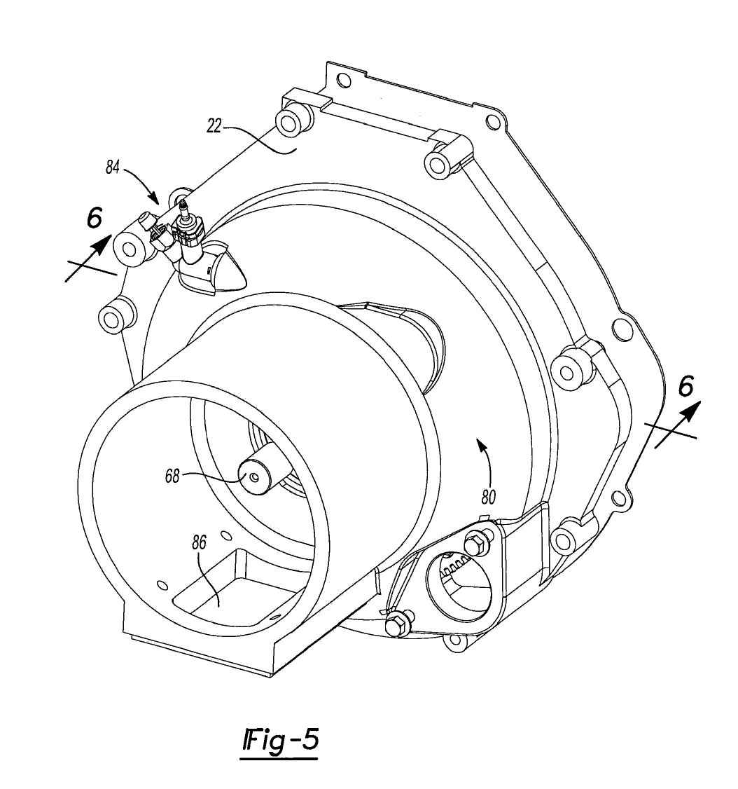

The backbone structure 18 may be flared out at the front (e.g. the bell housing 80) through the front mounting flange 22 to get around the flywheel/clutch assembly 82 to attach to the engine structure 20. This bell housing 80 may be a separate part, but maintains backbone stiffness by being rigidly attached to the backbone structure 18. Similarly, the rear of the backbone structure 18 can be flared to attach to the rear structure 16 through the rear mounting flange 24. The backbone structure 18 may also incorporate additional holes, such as holes 86 (FIGS. 3 and 5) and cover plates, such as cover plates 88 (FIG. 4) to provide access to the quill shaft 66 and/or the first and second couplers 70 and 74.

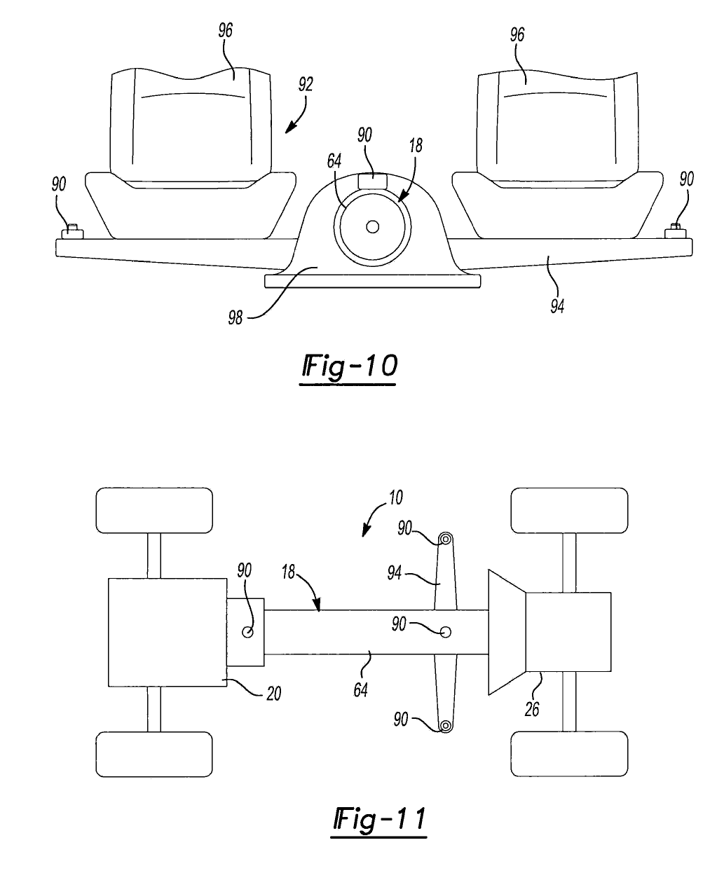

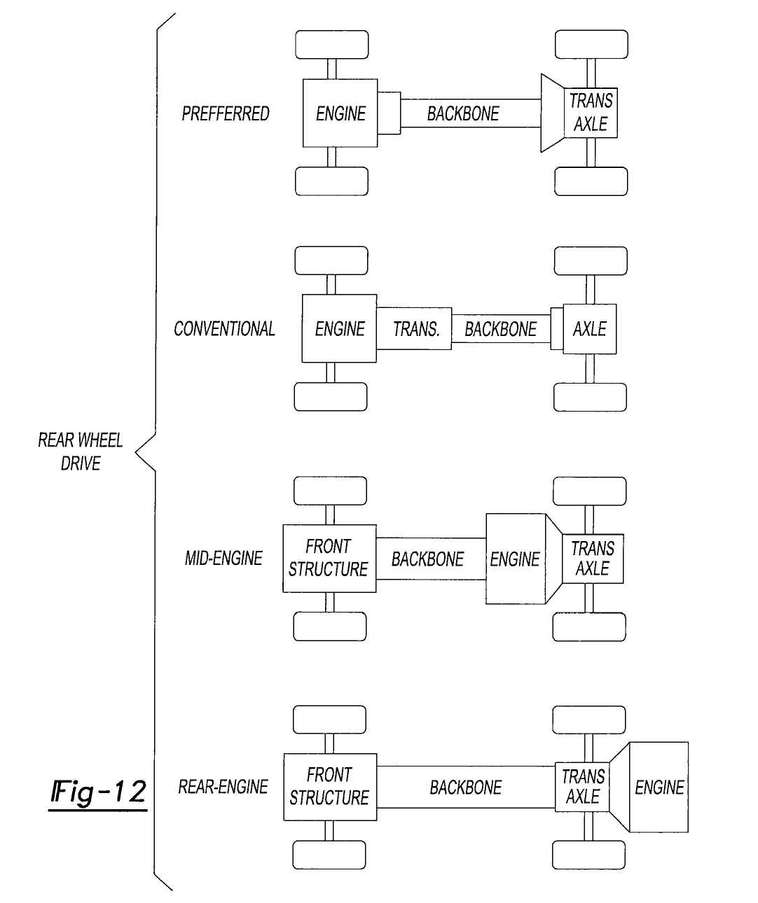

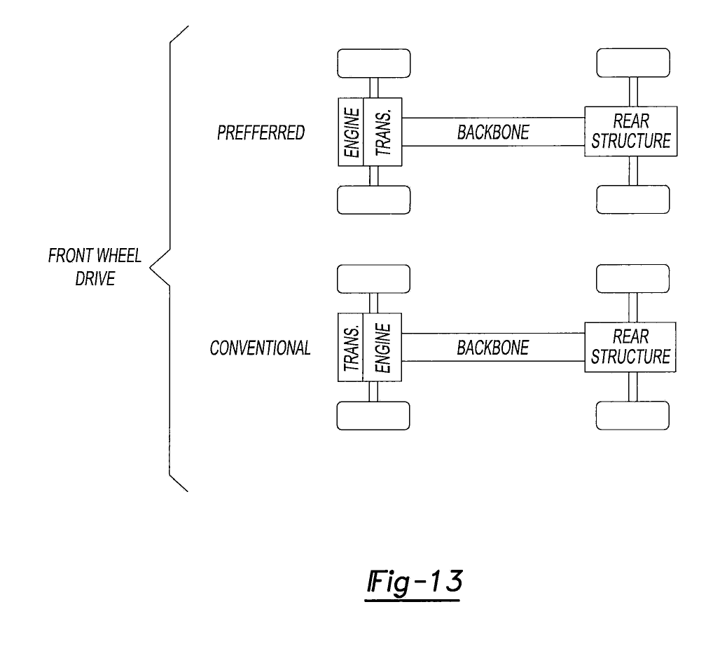

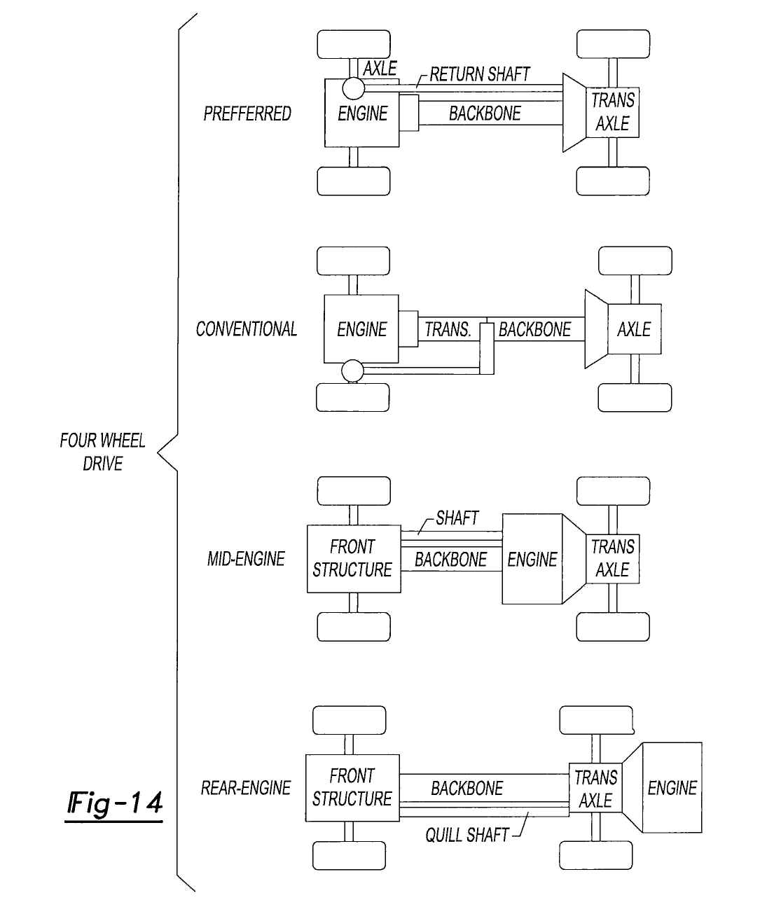

With reference to FIGS. 10 and 11, various exemplary body mounts 90 are shown. A vehicle body 92 includes a lateral beam or cross-member 94 coupled to the backbone structure 18. As can be appreciated, the vehicle body 92 can comprise various body components, such as seats 96. The cross-member 94 can be suitably attached to the backbone structure 18 at or near a torsional node defined in the tube 64. The uni-chassis 10 of the present invention allows various loads associated with the vehicle body 92 to be substantially de-coupled from various loads associated with the uni-chassis 10. A body tunnel 98 can be defined by the body 92. The body tunnel 98 can accommodate the tube 64.

While the preferred embodiment depicts a uni-chassis 10 utilizing the engine 20 as part of the front structure 14 and transaxle 26 as part of the rear structure 16, connected by a backbone structure 18, the uni-chassis concept can be applied to other powertrain arrangements. For example, a typical rear wheel drive (RWD) vehicle (such as the one shown in FIG. 1) with front engine 20 and transmission and rear drive shaft 56 can utilize the engine 20 and transmission as the core of the front structure 14 for attaching the front chassis systems, and the rear drive shaft 56 as the core of the rear structure 16 for attaching the rear chassis systems, connected by a backbone structure 18 incorporating a quill shaft 66 similar to that depicted in the preferred embodiment.

The application of the uni-chassis concept to this, and other powertrain arrangements, including front wheel (FWD) and four wheel (4WD) drive; are tabulated below:

TABLE 1
Alternative uni-chassis Powertrain Arrangements

| | | Front Structure | Backbone | Rear Structure |
|---|---|---|---|---|
| A. | RWD | Engine | Engine to Transaxle | Transaxle |
| | | Engine & | Transmission to Axle | Axle |
| | | Transmission | | |
| | | Front Chassis | Front Structure to | Engine & Transaxle |
| | | Structure | Engine | |
| | | Front Chassis | Front Structure to | Transaxle & Engine |
| | | Structure | Transaxle | |
| B. | FWD | Engine & Transaxle | Transaxle to Rear Structure | Rear Chassis Structure |
| | | Transaxle & Engine | Engine to Rear Structure | Rear Chassis Structure |
| C. | 4WD | Engine, Front Axle | Engine to Transaxle | Transaxle |
| | | Engine, | Transmission to Axle | Rear Axle |
| | | Transmission, Front | | |
| | | Axle | | |
| | | Front Axle | Front Axle to Engine | Engine & Transaxle |
| | | Front Axle | Front Axle to | Transaxle & Engine |
| | | | Transaxle | |

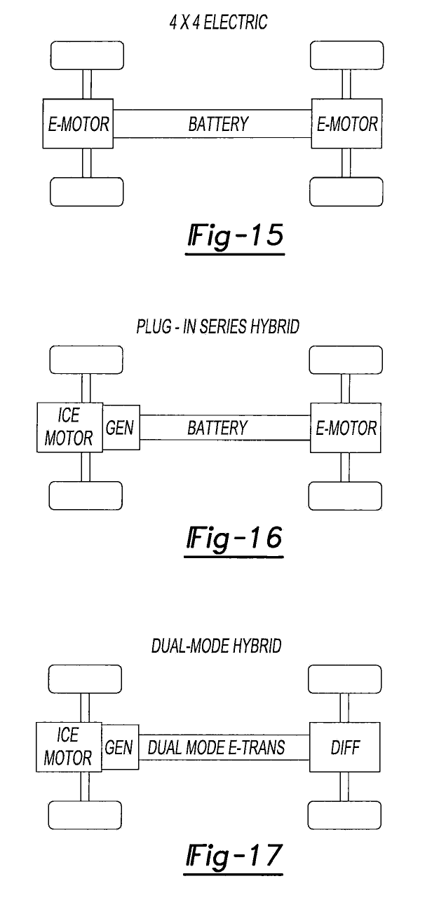

The uni-chassis concept is not limited in application to conventional powertrain technology. For example, an electric powertrain application (FIG. 15) might use a front motor for the front structure, a backbone structure to house the batteries, and a rear motor for the rear structure to create a four wheel drive (4WD) electric vehicle. A hybrid powertrain (FIG. 16) might use a front internal combustion engine and motor generator on a first end and an electric motor on an opposite end. Again, a backbone structure can house the batteries and connect front and rear structures. A dual mode hybrid powertrain (FIG. 17) might incorporate a differential at one end and a dual mode electronic transmission incorporated in the backbone structure. Many other arrangements of new powertrain technologies can be applied to the uni-chassis concept, by using one or more of the powertrain elements e.g., engine, transmission or axle, to create the core of the front or rear structures and connect them with a backbone.

An exemplary method of constructing a vehicle according to the present teachings will now be described. The present invention provides flexibility in creating a unique chassis for any given conventional vehicle (internal combustion engine, transaxle, suspension etc.) electric vehicle or hybrid vehicle while still maintaining the same uni-chassis architecture. In this way, a vehicle manufacturer (or assembler) can select a desired vehicle configuration and powertrain. A front and rear structure can be assembled to accommodate the selected vehicle configuration and vehicle powertrain. A central backbone structure can be assembled between the front and rear structures to create a rolling chassis. During attachment of the central backbone between the front and rear structures, the operational components (e.g., quill shaft for conventional vehicle, battery for electric or hybrid vehicle), are suitably coupled or connected. The closed tube of the central backbone can be made to any desired length suitable for the desired application. The desired vehicle body can then be coupled to the rolling chassis.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A chassis for use in an automotive vehicle, comprising:
a central backbone structure;
an engine;
a first structure supporting the engine and coupled to one end of the backbone structure;
a second structure coupled to the opposite end of the backbone structure; and
wherein ride and handling loads are transmitted between the first and second structures solely by the backbone structure.

2. The chassis of claim 2 wherein the central backbone structure further comprises:
a shaft rotatably housed within a closed tubular structure of the central backbone and configured to transmit a rotatable output from the engine to a rotatable input of a transaxle.

3. The chassis of claim 2 further comprising bearings, wherein the shaft is rotatably supported by the bearings arranged within the closed tubular structure.

4. The chassis of claim 2 wherein the backbone structure includes a first mounting flange coupled to a first mounting plate associated with the first structure and a second mounting flange associated with the second structure.

5. The chassis of claim 4, further comprising a bell housing integrally formed with the first mounting flange, the bell housing having at least one of a flywheel and a clutch pack assembly contained therewithin.

6. The chassis of claim 2 wherein the closed tubular structure defines a torque tube that transmits a torque between the first and second structures.

7. The chassis of claim 6 wherein the closed tubular structure is formed of aluminum having a wall thickness of substantially 0.5 inches.

8. The chassis of claim 1 wherein the second structure is built around a transaxle.

9. The chassis unit of claim 1 wherein the engine is an electric motor, the chassis further comprising at least one battery housed within the backbone structure.

10. The chassis of claim 1 wherein the engine is an internal combustion engine and wherein the second structure includes an electronic motor.

11. The chassis of claim 1 further comprising at least two systems taken from the group comprising: a front wheel drive system, a rear wheel rive system, a four wheel drive system, an electric system and a hybrid system and wherein the backbone structure is coupled in a first arrangement to one of the systems of the group and coupled in a second arrangement to another of the systems of the group.

12. The chassis of claim 1 wherein the engine and the first structure are provided on a front end of the automotive vehicle.

13. The chassis of claim 1 wherein the engine is provided on a rear end of the automotive vehicle.

14. The chassis of claim 1 wherein the engine is positioned intermediate to the front structure and the backbone structure.

15. An automotive vehicle chassis, comprising:
a central backbone structure defining an outer cylindrical tube having a first mounting flange adjacent one end and a second mounting flange adjacent an opposite end;
an engine;
a shaft rotatably supported within the outer cylindrical tube and driven by the engine;
a first structure supporting the engine and coupled to the first mounting flange of the backbone structure;
a transaxle driven by the shaft;
a second structure supporting the transaxle and coupled to the second mounting flange on the opposite end of the backbone structure; and
a vehicle body coupled to the backbone structure at a torsional node defined in the outer cylindrical tube;
wherein chassis loads are transferred between the first and second structures entirely by the backbone structure and are substantially de-coupled from body loads.

16. The chassis of claim 15 wherein the shaft is rotatably supported by bearings arranged within the outer cylindrical tube.

17. The chassis of claim 15, further defining a bell housing integrally formed with the first mounting flange, the bell housing having at least one of a flywheel and a clutch pack assembly contained therewithin.

18. The chassis of claim 15 wherein the outer cylindrical tube is formed of aluminum having a wall thickness of about 0.5 inches.

19. A method of manufacturing a vehicle, the method comprising:
selecting a vehicle configuration from a group essentially comprising: a rear wheel drive configuration, a front wheel drive configuration, and a four wheel drive configuration;
selecting a vehicle powertrain from a group essentially comprising: an internal combustion engine, an electric motor, and a combination thereof;
assembling a front structure to accommodate the selected vehicle configuration and vehicle powertrain;
assembling a rear structure to accommodate the selected vehicle configuration and vehicle powertrain;
coupling a central backbone structure between the front and rear structures to create a rolling chassis, the central backbone structure operable to accommodate ride and handling loads between the front and rear structures; and
attaching a vehicle body to the rolling chassis.

20. The method of claim 19, further comprising:
determining an optimal length of the central backbone structure based on the selected vehicle configuration and vehicle powertrain; and
assembling the central backbone structure based on the determined optimal length.

21. The method of claim 20 wherein assembling the central backbone structure comprises:
rotatably disposing a quill shaft through a closed tube;
coupling a first end of the quill shaft to an engine output shaft; and
coupling a second end of the quill shaft to a transaxle input shaft;

22. The method of claim 20 wherein assembling the central backbone structure comprises:
locating at least one battery within the central backbone structure.

23. The method of claim 21 wherein attaching the vehicle body comprises:
attaching the vehicle body substantially at a torsional node defined by the closed tube.
